(19) United States
(12) Patent Application Publication
(10) Pub. No.: US 2007/0168137 A1
(43) Pub. Date: Jul. 19, 2007

(54) Method for modeling and refining molecular structures

(76) Inventors: Yong Duan, Davis, CA (US); Wei Zhang, Knoxville, TN (US)

Correspondence Address: MCCARTER & ENGLISH, LLP;BASIL S. KRIKELIS, CITIZENS BANK CENTER, 919 N. MARKET STREET, SUITE 1800, WILMINGTON, DE, 19801, US

(21) Appl. No.: 11/641,387

(22) Filed: Dec. 19, 2006

Related U.S. Application Data
(60) Provisional application No. 60/752,776, filed on Dec. 21, 2005.

(51) Int. Cl. G06F 19/00

(52) U.S. Cl. 702/19

(57) ABSTRACT

A method for modeling and refining reduction of the side chain size to obtain a smooth energy landscape due to the increased distances between the side chains. The side chains then gradually grow back during molecular dynamics simulations while adjusting to their surrounding driven by the interaction energies. The method of the invention overcomes barriers resulting from tight packing that limit conformational sampling of physics-based models.

### RELATED APPLICATIONS

The present application claims the benefit of U.S. Provisional Application Ser. No. 60/752,776 filed Dec. 21, 2005, the disclosure of which is expressly incorporated herein by reference in its entirety.

### RELATED FEDERALLY SPONSORED RESEARCH

The work described in the present application was sponsored by the National Institutes of Health (NIH) under Contract Numbers R01GM64458 and R01GM67168. Accordingly, the Government may have certain rights to the present invention.

### FIELD OF THE INVENTION

The present invention relates to computational methods for predicting tertiary protein structures, refining protein structures, modeling protein-protein and protein-ligand interactions, and to computer-implemented apparatus performing such computations.

### BACKGROUND OF THE INVENTION

Protein structure prediction technology aims to determine three-dimensional structures of proteins from amino acid sequences computationally. Protein structure information is highly useful for several purposes, including rational drug design. Determination of protein structure experimentally, however, remains laborious, time-consuming, and expensive. Accordingly, computational protein structure determination is attractive as it offers the opportunity to accelerate drug development and other areas of research. Potential applications of protein prediction technology include protein structure prediction and refinement, protein side chain assignment and refinement, drug design and refinement, and structure refinement of protein complexes.

The importance of protein structure prediction has increased tremendously as modern DNA sequencing technology has generated enormous amounts of protein sequence information. Efforts such as the Human Genome Project have resulted in massive amounts of genetic information that is easily translated into protein amino acid sequences. The advances in genomic technology makes finding the amino acid sequence for a protein of interest largely routine.

The output of experimentally determined protein structures is lagging far behind the output of protein sequences. Experimental determination of protein structures typically involves time-consuming and relatively expensive X-ray crystallography or NMR spectroscopy. These techniques are severely limited in that they can only be used to determine the structure of proteins satisfying specific criteria. In order to use X-ray crystallography to determine a protein's tertiary structure, the protein must form well-ordered crystals that can withstand X-ray radiation. Many proteins are not amendable to the crystal formation process because they exist in a heterogeneous form or contain hydrophobic regions which disrupt crystallization. Regarding NMR spectroscopy, this technique becomes increasingly difficult as the protein size increases.

A number of factors exist that make protein structure prediction a very difficult task. The number of possible structures that proteins may possess is extremely large and the physical basis of protein structural stability is not fully understood. A particular sequence may be able to assume multiple conformations depending on its environment, and the biologically active conformation may not be the most thermodynamically favorable. Because of the many difficulties associated with protein structure determination, direct simulation of protein folding by molecular dynamics faces many challenges.

Ab initio- or de novo-protein modelling methods seek to build three-dimensional protein models based on energy minimization of the molecular configuration. The energy calculations are based on physical principles, and attempt to mimic protein folding or apply stochastic methods to search possible solutions, such as optimization of an energy function.

Even structure prediction methods that are reasonably accurate for the peptide backbone are often fail to accurately predict the orientation and packing of the amino acid side chains. Some methods specifically address the problem of predicting side chain geometry by isolating the continuously varying dihedral angles of the side chain's orientation relative to the backbone into a set of rotamers with fixed dihedral angles. Then, a set of rotamers that minimize the model's overall energy can be identified. Such methods are useful for analyzing a protein's hydrophobic core, where side chains tend to be more closely packed.

The hydrophobic interior of a protein creates a rough energy landscape that includes many local energy minima. The tightly packed protein interiors typically seen in well-folded proteins are extremely sensitive to the detailed side chain packing in energy minimization calculations. Even a slight error in assignment of the side chains can create molecular collisions which result in high energy calculations and instable structures, complicating any subsequent refinement.

When mispacking occurs, rearrangement of the mispacked side-chains typically requires unfolding the protein backbone because the without complete unfolding, the backbone will computationally collide with neighboring side-chains. Thus, proteins often need to unfold from a mispacked state to continue to search for the correctly packed state. Unfolding and refolding, however, further complicates the conformational search. The combination of the rough energy landscape and tight packing of protein interiors have prevented wide application of physics-based, all-atoms models in protein structure prediction generally, and specifically in protein side chain assignment and structure refinement of protein-ligand complexes.

Correct assignment of side chains is an important step in protein structure prediction because the ultimate goal is to provide a biochemical framework for physical interpretation of protein functions. Because of the rough energy landscape, however, optimal assignment of protein side chains remains a challenging task. A common problem confronting all side chain assignment methods is that small errors in the backbone coordinates can force incorrect choice of side chain rotamers. Therefore, methods that can combine side chain assignment and main chain structure refinement are very much needed.

### SUMMARY OF THE INVENTION

The invention includes method for modeling a molecule having a refined protein structure. The method comprises the steps of producing a reduced molecular model of a molecule and growing said reduced molecular model to a normal size while adjusting to a local environment using a molecular dynamics simulation process.

The invention also includes another method for modeling a molecule having a refined protein structure. This method comprises the steps of providing a model of a molecule and a local environment in a computer system, adjusting a scaling term of an energy function corresponding to said molecule, reducing the model to form a reduced molecular model, and growing said reduced molecular model to a normal size in said local environment. In this method, the energy function controls growth of the reduced molecular model to produce a refined protein structure for the reduced molecular model.

Also included is a method for modeling protein side chain assignment. His method comprises the steps of reducing a high energy barrier associated with a molecule to produce a model of a smooth energy surface in a computer system, and modeling growth of a protein structure in the computer system by simulating assignments of protein side chains. In this method, the assignments are controlled by the model of the smooth energy surface.

### BRIEF DESCRIPTION OF THE DRAWINGS

FIG. 1 is a flowchart showing the method of the present invention in detail.

FIG. 2A is a graphic model of leucine dipeptide scaled by λ=0.6.

FIG. 2B is a graphic model of leucine dipeptide shown in normal size. The leucine is represented by sticks and balls and only the side chain is scaled.

FIG. 3 is a table showing potential energy profiles of normal and scaled Leucine dipeptide.

FIG. 4 shows the potential energy profiles of other 16 Ace-X-Nhe dipeptides.

The normal and scaled (λ=0.6) potential energy profiles are represented by solid and dashed lines, respectively.

FIG. 5 is a table showing the potential of mean force (PMF) profiles of a partially exposed residue SER50 in a protein (PDB ID: 1fna). The shrink case is for λ=0.6.

FIG. 6 shows a sampling of a single buried side chain ILE54 of protein 1fna during the simulation as measured by the deviations of χ1 (blue) and χ2 (red) angles from the native position (dchi) at the end of each cycle (A) and after Monte Carlo step (B).

FIG. 7 shows a side chain sampling of 5 buried residues of protein 1fna as measured by the deviations of χ1 (blue) and χ2 (red) angles from the native position (dchi) at the end of each cycle (A) and after Monte Carlo step (B).

FIG. 8 shows a sampling of all 15 buried side chains of protein 1fna as measured by the deviations of χ1 (blue) and χ2 (red) angles from the native position (dchi) at the end of each cycle (A).

FIG. 9 shows a sampling of all 15 buried side chains of protein 1fna as measured by the deviations of χ1 (blue) and χ2 (red) angles from the native position (dchi) after Monte Carlo step (B).

FIG. 10 shows a sampling of an exposed residue GLU41 of protein 1fna as measured by the deviations of χ1 (blue) and χ2 (red) angles from the native position (dchi) in regular MD simulations (A) and at the end of each G2FMD cycle (B) and after Monte Carlo step in G2FMD (C).

FIG. 11 shows a G2FMD side chain assignment of entire proteins. Accuracy was averaged over all protein residues. Chi1 and Chi12 represent χ1 and χ1+2, respectively.

### DETAILED DESCRIPTION OF THE INVENTION

The present invention relates to a method for modeling and refining protein structures. The method of the present invention represents an ab initio approach that utilizes molecular mechanics simulations for protein side chain and/or ligand structure assignment and refinement that contemplates rotamer-based methods. By reducing the side chain and/or ligand size, smooth energy landscape is obtained due to the increased distances between the side chains and/or between ligand and protein. The side chains and ligands then gradually grow back during molecular dynamics simulations while adjusting to their surrounding driven by the interaction energies. The method of the invention overcomes barriers resulting from tight packing that limit conformational sampling of physics-based models. The resulting structures from this method are free from steric collisions and allow application of all-atom models in the subsequent refinement.

The method was tested on small sets of proteins and approximately 100% accuracy was achieved on both χ1 and χ2 of buried residues. Overall, more than 94% of the torsion angles were within 20° from the native conformation, 79% were within 10° and 42% were within 5°.

The present invention provides a method for modeling and refining molecular structures which utilizes ab initio all-atom molecular mechanics force field to assign and to refine protein side chains. The side-chain and/or ligand assignment and refinement method of the present invention overcomes the steric collision problem by decreasing the size of side chain groups and/or ligands first and then allowing the side chains and/or ligands to adjust to the local energy landscape as they slowly grow back. Meanwhile, the reduction in side chains and/or ligands reduces the energy barriers and accelerates the conformational search process. The present method generates a smoother energy landscape which greatly improves the conformational sampling efficiency. As shown in Example 1, discussed below, the present method can find the correct side chain positions with high accuracy.

The computational method of the invention first reduces the sizes of the molecules (ligand or side chains). The molecules gradually grow back and in the meantime adjust to the surrounding environments. The novelty of the method is that it allows the molecule to fit to the environment and produce the most favorable structure and remove the high energy barriers to allow efficient sampling of the conformations.

The method of the present invention enables efficient sampling of important conformations, to allow accurate calculation of the most favorable structures and binding constants. Potential applications of the invention include 1) protein side chain assignment and refinement, 2) protein structure prediction and refinement, 3) drug design and refinement, 4) structure refinement of protein complexes. Example 1, discussed below, illustrates the application of the present invention in protein side chain assignment and refinement.

The present invention provides a method for modeling a molecule having a refined protein structure. A refined protein structure is a protein structure that reveals the tertiary structure of a protein backbone and side chains. In order to develop a model of the molecule, the method includes the steps of producing a reduced molecular model of a molecule and growing the reduced molecular model to a normal size. The reduced molecular model comprises the polypeptide backbone, and the normal size includes the amino acid side chains. Growing the reduced molecular model is done while adjusting the model to a local environment using a molecular dynamics simulation process.

In one embodiment of the method, the molecule being modeled is a polypeptide, and in another embodiment, the polypeptide includes amino acid side chains. In another embodiment, the molecule includes a ligand.

The method can further include the step of adjusting a scaling term of an energy function corresponding to the molecule prior to producing the reduced molecular model. Here the notion of “scaling term” indicates the individual energy term of the energy function to be adjusted and scaled in the calculations. Adjusting the scaling term includes any one of adjusting an angle of the energy function, adjusting a dihedral term of the energy function, adjusting a bond term of the energy function, adjusting an electrostatic term of the energy function, and adjusting a van der Waals term of the energy function. These terms are defined explicitly below in reference to the “AMBER” energy function. Other known energy functions that can be used in accordance with this method include CHARMM, OPLS-AA, MMFF, and other molecular mechanics energy functions.

In another embodiment, the step of growing the reduced molecule can include shrinking the side chains of the molecule, or growing the side chains to a normal size. The method can also include performing an energy minimization process on the reduced molecule. The energy minimization process can include saving minimized energy parameters of the reduced molecule, and re-modeling the reduced molecular model using the saved minimized energy parameters.

In yet another embodiment, the invention includes a method for modeling a molecule having a refined protein structure that includes the steps of providing a model of a molecule and a local environment in a computer system, and adjusting a scaling term of an energy function corresponding to said molecule. The method also includes reducing the model to form a reduced molecular model and growing the reduced molecular model to a normal size in the local environment. Here, the energy function controls the growth of the reduced molecular model to produce a refined protein structure for the reduced molecular model. In this embodiment, the step of adjusting a scaling term can include adjusting a dihedral term of the energy function, adjusting a bond term of the energy function, adjusting an electrostatic term of the energy function, or adjusting a van der Waals term of the energy function.

The step of reducing the model typically includes shrinking the side chains of the model, and the step of growing the reduced molecule includes growing the side chains to a normal size. In another embodiment, the method also includes performing an energy minimization process on the reduced molecular model, and in another embodiment, the method further includes saving minimized energy parameters of the reduced molecular model. These saved minimized energy parameters can be use to re-modeling the reduced molecular model.

Also provided is a method for modeling protein side chain assignment. This method includes reducing a high energy barrier associated with a molecule to produce a model of a smooth energy surface in a computer system. This method also includes the step of modeling the growth of a protein structure in the computer system by simulating assignments of protein side chains. In this method, the protein side chain assignments are controlled by the smooth energy surface model.

In still another embodiment, the method can include adjusting the scaling terms of an energy function governing the smooth energy surface. This step can include adjusting a bond term of the energy function, adjusting an electrostatic term of the energy function, or adjusting a van der Waals term of the energy function.

The present invention includes steps for producing a reduced molecular model of a molecule and growing the reduced molecular model to a normal size. The reduction of the size of important parts of macromolecules (e.g. protein side chains) reduces the complexity of protein energy surface and allows the system to move efficiently towards the most favorable structures. This is followed by a procedure in which the reduced molecular model grows back to the normal size while adjusting to the local environment during a molecular dynamics process. A direct consequence of the reduction in the sizes is the removal of high energy barriers that trap the molecules into local energy minimum and prevents the molecules from moving to other important (perhaps more stable) conformations.

In the method of the present invention, accurate side chain assignment requires both the ability to locate the low-energy conformations and the accurate representation of the energy surface, particularly in terms of side chain energies. The method serves to enhance the conformational sampling by making the energy surface smoother and does so while preserving the important features of the free energy landscape. The large steric energy barriers at the protein interior make it very difficult to search the conformational space with ab initio methods. From this perspective, tests on the buried side chains, as set forth in Example 1 discussed below, clearly demonstrate that the present invention significantly enhances sampling.

The method of the present invention smoothes the energy landscape by decreasing the size of side chain groups and enables proteins to transfer among different conformations without unfolding their backbone structure. The smooth energy landscape allows for application of molecular mechanics simulation to the side chain assignment. The method demonstrated nearly 100% accuracy on all 6 randomly chosen proteins (see Example 1). The results achieved with the present invention, such as the correct simultaneous assignment of all the buried side chains, and the notably small deviation from the native conformations (especially for both χ1 and χ2), are superior to previous known methods.

In the present method, the size of side chain groups is reduced. One advantage of reducing the size of the side chains is that steric collisions do not impede correct confirmations and side chains are permitted to rearrange more easily.

As mentioned earlier, accurate force field and sufficient conformational searching are two important aspects in protein structure prediction. The methods of the present invention allow side chain groups to find their native conformations as their conformations are influenced by the physical driving forces when the side chain groups grow back to their normal size. In tests of the present invention, presented in Example 1, using 1fna (Tables 1a and 1b below), six of the buried side chains on the molecule were polar and formed hydrogen bonds. These residues included tyrosine, threonine, and serine residues, including Tyr27, Thr30, Tyr63, Thr66, Thr71, Ser79. In all cases, it was observed that these side chains were correctly assigned.

There are various applications of the present invention, including, for example, protein side chain assignment and refinement; protein structure prediction and refinement; drug design and refinement; and structure refinement of protein complexes.

Protein side chain assignment and refinement. The rough energy landscapes and tight packing of protein interiors are some of the critical factors that have prevented wide application of physics-based models in protein side chain assignment and protein structure prediction in general. By reducing the side chain size, smooth energy landscape is obtained due to the increased distances between the side chains. The side chains then gradually grow back during molecular dynamics simulations while adjusting to their surroundings driven by the interaction energies. The method of the present invention overcomes the barriers due to tight packing that limits conformational sampling of physics-based models. The results are considerably better than the existing methods based on rotamer libraries.

Protein Structure refinement. The significance of protein prediction is best exemplified by the development of Structural Genomics, an initiative geared toward solving a large number of protein structures of remote homology to cover the fold space and to allow structures of all other proteins being solved through homology modeling. One component is the development of reliable protein structure prediction methods. Although the all-atom approach has the potential to improve protein structure prediction, the rough energy landscapes and tight packing of protein interiors have been some of the critical factors that have prevented wide application of all-atom models in protein structure prediction. Thus far, application of all-atom models in structure prediction has been rather limited. It is typically involved in the final steps of protein structure prediction in which molecular mechanics and all-atom models are utilized to remove steric clashes due to mispacking of protein side chains. In the all-atom model, an energy minimization is conducted to allow minor (local) adjustments of protein structures. Because of the rough energy surface and tight packing, energy minimization often cannot move the structure. In many such cases, the tight packing of the side chains can move the protein structures away, resulting in structures that are worse than the structures before the procedure.

The rough energy surface resulting from tight packing of side chains in the protein interior creates difficulties in refinement. The methods of the present invention overcomes this problem by reducing the side chains first, thus reducing energy barriers and allowing the protein to move around and adjust to the structures dictated by the energy surface. In this regard, the procedure makes the energy surface smoother. The side chains then “grow” back to the normal size during molecular dynamics steps which allow the side chains and the protein to further adjust to the more favorable structures.

Drug Design and Refinement. In-silico design has been widely used in pharmaceutical industry to design novel drugs. A key step in this design is docking the perspective ligands and small molecules to the possible targets (proteins or other biomolecules) to fit to the binding sites and calculate the binding affinity constant which helps to evaluate the potency of the compound. A key problem is that when a ligand binds to the target, local structures often undergo conformational changes in response to the interactions. For example, one can imagine a perspective compound may not bind to the present form of pocket well, but may bind very well to a pocket that is ever so slightly different. Accounting for this inherent flexibility is important for an accurate calculation of the binding affinity which can help accurate screening of the potential compounds. However, this is a challenging problem for computational modeling largely because of the rough surface. The methods of the present invention can greatly help. First, it helps to account for the side chain and receptor (host) flexibility. By reducing the side chains and parts of the host, the binding site can be made smoother which helps the ligand move around to fit to the best site. Second, it also helps to account for the flexibility of the ligands. This is often a critical issue in flexible docking. In the present invention, parts of the ligands can be made smaller initially and can grow back slowly while adjusting to the environment.

Protein-protein Docking and Interaction. Proteins realize their functions by interacting with other molecules, including proteins, nucleic acids, carbohydrates, membrane lipids, and many other molecules. By reducing the side chains of the docking site first, the methods of the present invention can make the surface smoother. The slow growth steps ensure that the molecules can find their way to fit each other.

### EXAMPLES

### Example 1

A. Grow to Fit Molecular Dynamics (G2FMD)

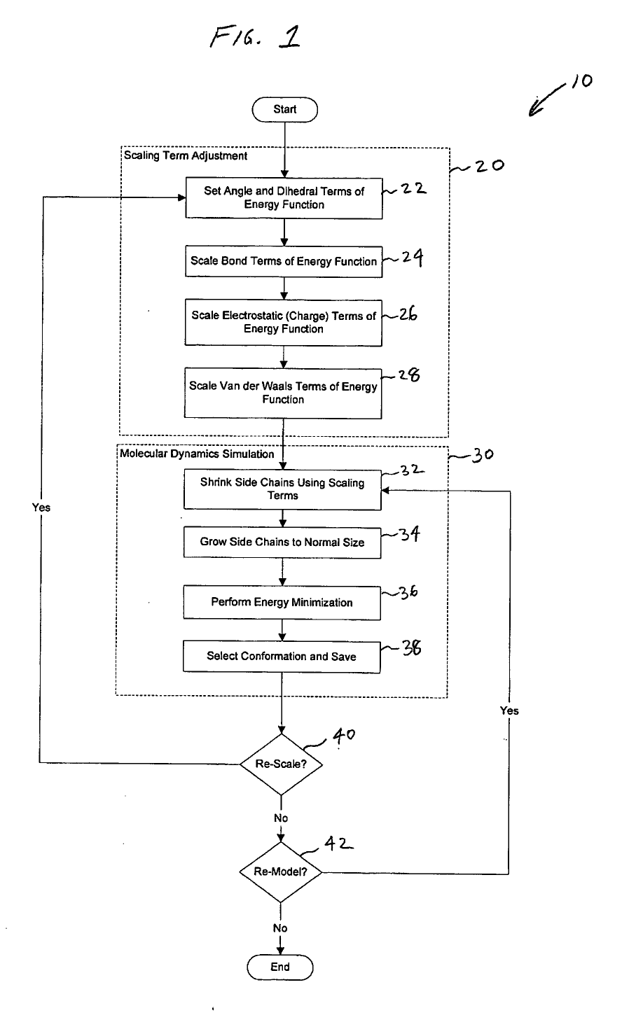

FIG. 1 is a flowchart, indicated generally at 10, showing processing steps of the method of the present invention in greater detail. The overall steps of the method are described herein with reference to sample parameters as set forth in the present example which have been tested and resulted in successful modeling and molecular refinement.

Generally, the method of the present invention includes a scaling term adjustment process 20 and a molecular dynamics simulation process 30. In process 20, which includes steps 22-28, the side chain groups of a molecule to be modeled are first reduced by reassigning the coordinates of side chain atoms and scaling down side chain bonds. The so-called “AMBER” energy function is utilized in the method of the present invention, and includes the following terms:

$$\begin{matrix}U ( R ) = {\sum }_{bonds} {{K}_{r} ( r - {r}_{eq} )}^{2} + & bond \\ {\sum }_{angles} {{K}_{θ} ( θ - {θ}_{eq} )}^{2} + & angle \\ {\sum }_{dihedrals} \frac{{V}_{n}}{2} ( 1 + cos [ n ϕ - r ] ) + & dihedral \\ {\sum }_{i < j}^{atoms} ( \frac{{A}_{ij}}{{R}_{ij}^{12}} - \frac{{B}_{ij}}{{R}_{ij}^{6}} ) + & van der Waals \\ {\sum }_{i < j}^{atoms} \frac{{q}_{i} {q}_{j}}{ɛ {R}_{ij}} & electrostatic\end{matrix}$$

In step 22, the angle and dihedral terms of the energy function are set. Preferably, the angle and dihedral terms are kept unchanged during resealing (discussed later).

In steps 24-28, the bond, van der Waals and electrostatic terms of atom i are scaled according to the scaling parameter λᵢ (0≦λᵢ≦1). In the present example, for atoms that were not subjected to scaling, the scaling parameter λᵢ was a constant (λᵢ=1); for those that were subjected to scaling λᵢ=λ which is varied during the simulation (0≦λ≦1).

In step 24, the bond terms of the energy function are scaled. In the present example, successful results have been developed by keeping the bond terms and the bond force constant, Kᵣ, unchanged. For the bond between atoms i and j, the r_{eq} was varied by scaling to r_{eq}=λᵢⱼr_{eq}⁰, while

$${λ}_{ij} = \frac{1}{2} ( {λ}_{i} + {λ}_{j} )$$

and r_{eq}⁰ was the unscaled (standard) equilibrium bond length in the AMBER force field. Thus,

$${λ}_{ij} = λ , \frac{1}{2} ( 1 + λ ) ,$$

1, if the scaling was applied to, respectively, both bonded atoms, only one of the two, or none of the two atoms. For example, bonds between C_{α} and C_{β} were scaled as

$$\frac{1}{2} ( 1 + λ )$$

since only C_{β} was subjected to scaling and C_{α} is part of the main chain atom and was not subjected to scaling.

In step 26, the electrostatic (charge) terms of the energy function are scaled. In the present example, the charges were scaled as qᵢ=\sqrt{λᵢ}qᵢ⁰, while qᵢ⁰ was the unscaled AMBER charge of atom i. Thus, the electrostatic interaction between two scaled atoms was scaled by λ With this scaling scheme, the electrostatic interaction energy between the scaled atoms within the same side chain group were kept unchanged during the resealing because both distance and charges were scaled at the same rate.

In step 28, the van der Waals terms of the energy function are scaled. In the present example, the van der Waals parameters Aᵢⱼ and Bᵢⱼ were scaled by adjusting the van der Waals radii of atoms i and j. This was accomplished by scaling σᵢⱼ=λᵢⱼ⁰ in the Lennard-Jones potential

$${ϕ}_{ij} ( r ) = 4 {ɛ}_{ij} ( \frac{{σ}_{ij}^{12}}{{r}_{ij}^{12}} - \frac{{σ}_{ij}^{6}}{{r}_{ij}^{6}} ) ,$$

where σᵢⱼ⁰ is the van der Waals parameter without scaling. Again,

$${λ}_{ij} = \frac{1}{2} ( {λ}_{i} + {λ}_{j} )$$

was the combined scaling parameter. In this way, the rescaled van der Waals potentials were also kept unchanged for atoms of the same side chain groups because their radius and distance were scaled with the same rate. However, van der Waals interactions with other parts of the protein were scaled (reduced) accordingly. An implication of these scaling schemes of van der Waals and charges is that the 1-4 electrostatic and 1-4 van der Waals terms are also kept constant within the same side chain groups. This further implies that the dihedral terms can be kept unscaled because of the coupling between 1-4 terms and dihedral energy, which, in combination, serve to achieve a balanced energy profile in the dihedral space.

Series trial simulations were launched to test the scaling parameters discussed above. Results showed that the sampled conformational space decrease noticeably when the time of grow cycle was less than 1 ps. Because backbone atoms were not rescaled, the shrunken side chains tend to collapse with backbones when the scaling parameter λ became smaller than 0.4. Balancing among simulation time, sampling efficiency and the possibility of collision, 10 ps and 1 ps were chosen for the growth and shrink steps (described in next paragraph) respectively, and λ was set to 0.6≦λ≦1. The simulations were stopped arbitrarily after 200 growth and shrink cycles (2.2 ns) which took about one day to complete on a dual-CPU 2.4 GHz Intel Xeon PC.

After rescaling the side chain groups in process 20, molecular dynamics simulation using the scaled parameters is carried out in process 30, which includes steps 32-38. Generally, the process 20 can be described as involving two iterative processes, namely: shrink and growth. In step 32, the side chains were reduced by scaling the coordinates. In this way, collisions due to incorrect assignment (e.g., random assignment) were removed. Then, in step 34, the scaled groups are gradually grown back to their normal size in 10 ps while the relevant parameters were updated every 10 steps. In step 36, energy minimization is performed at the end of each molecular dynamics (“MD”) cycle to remove the energy fluctuation inherent in MD simulations. In step 38, the energy is compared against the one saved from the previous cycle and a conformation is selected by the Monte Carlo procedure (at 300 K). The selected conformation is saved and becomes the starting structure in the next cycle which is started by gradually reducing the side chains to 60% of the normal size in 1.0 ps. In step 40, a determination is made as to whether to adjust (re-scale) the scaling terms described above. If a positive determination is made, process 20 is repeated. If a negative determination is made, step 42 is invoked, wherein a determination is made as to whether to re-model using the molecular dynamics simulation process 30. If a positive determination is pate, process 30 is repeated. If a negative determination is made, modeling is completed.

It should be noted that the molecular backbones modeled by the present invention were restrained by a harmonic force (5.0 kcal/mol-Å²) in all simulations. In the single side chain assignment, the target side chain was first assigned randomly. During the G2FMD simulation, the shrink-and-grow cycle was applied only to the selected side chain group, while all the other atoms were restrained to the native conformation by harmonic forces (5.0 kcal/mol-Å²). In the multiple side chain assignment, the target side chains were first assigned randomly and the shrink-and-grow cycle was simultaneously applied to all the selected side chain groups, while other atoms were restrained. Similarly, for the assignment of the entire protein side chains, all the side chain groups were initially assigned randomly and all the side-chain groups underwent shrink-and-grow cycles simultaneously while only the backbone was restrained.

Assignment tests were performed separately on the exposed and buried side chains. A side chain was considered buried if the solvent accessible surface area, calculated using NACCESS, was less than 20% of its total surface area. Otherwise, it was considered exposed.

B. Simulation Protocols

The proteins and peptides were represented using Duan et al force field (also known as AMBER ff03 force field). A modified version of the known “AMBER 8” simulation package was used in all simulations. All bonds were constrained by the known “SHAKE” algorithm to allow an integration time step of 1.0 fs. A Generalized Born (GB) implicit solvent model was applied to model the solvation effect, with an effective 0.2 M salt concentration. Surface area terms were not explicitly modeled in the GB model for their contribution is typically small. The interior and solvent dielectric constants were set to, respectively, 1.0 and 78.5. Simulations were done at constant temperature ensemble and the temperature was maintained at 300 K by Berendsen thermostat.

C. Results and Discussion

In this section, the impact of the scaled side chains by calculating the energy profiles of individual side chains modeled as di-peptides is discussed. A potential of mean force (PMF) of a selected side chain was calculated in the contest of a protein. The accuracy of side chain assignment and refinement were tested on a number of proteins. Here, the detailed results on the human cell adhesion protein (PDB code 1fna) are presented. First, its ability to assign single side chains is tested. This is considered relatively simple that is designed to give best-case results since it avoids the combinatorial problems. Assignment tests of multiple buried and exposed side chains are presented next. Finally, test assignments for the entire protein and for other proteins are presented.

i. Energy Profiles with Scaled Side Chains

Interactions between peptide backbone and side chains are some of the most important determinants of both side chain and main chain conformations. In molecular mechanics, the interactions are modeled by a combination of electrostatic, van der Waals, torsion potentials and, to a less extent, also by bond and bond angle interactions. The later two are hard degrees of freedom that play minor roles to determine side chain conformations at room temperature. These parameters might be correlated to some extent and were developed for the full size side chains.

In this example of the method, all components were reduced in a consistent manner to minimize differences. To verify this, the energy profiles of the scaled di-peptides (Ace-X-Nhe) were compared to the normal energy profiles for 17 amino acids. Amino acids Ala, Gly were excluded from the tests because they both have trivial side chains. Pro was kept normal size in this study because the ring structure is relatively rigid and its small side chain typically poses no significant problems in side chain assignment.

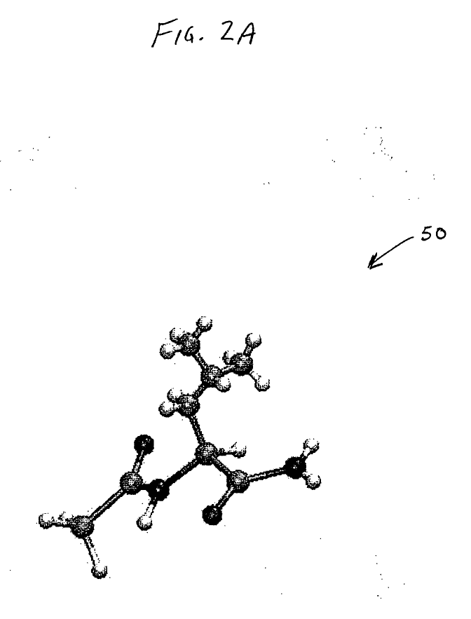

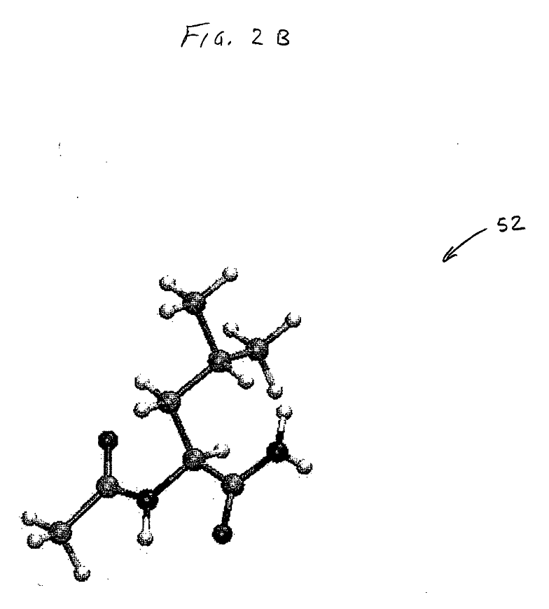

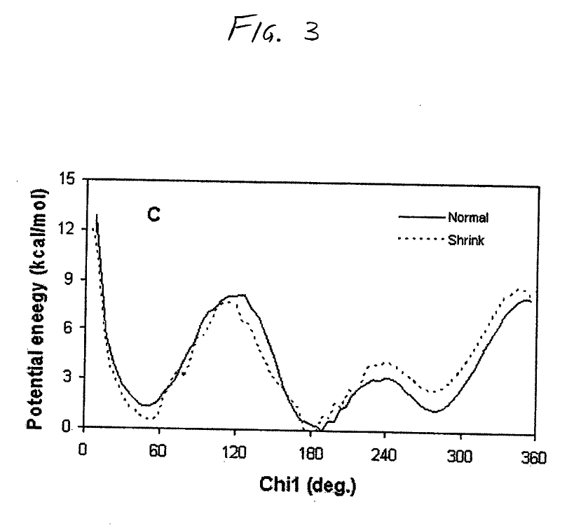

FIGS. 2A and 2B illustrate the normal and reduced leucine di-peptides (Ace-Leu-Nhe), respectively. The leucine side chain is represented by sticks and balls and the reduced side chain is 60% of its normal size. FIG. 3 shows the energy profiles of the di-peptides, calculated by energy minimization while restraining the χ1 torsion angle. Overall, the energy profiles are highly similar and the main features of the full size side chain energy profile were well preserved after the side chain was scaled. The overall root-mean-square difference between the energy profiles was less than 1.0 kcal/mole. The similarity between the energy surfaces indicates that the change in side chain size did not dramatically alter the energy profiles.

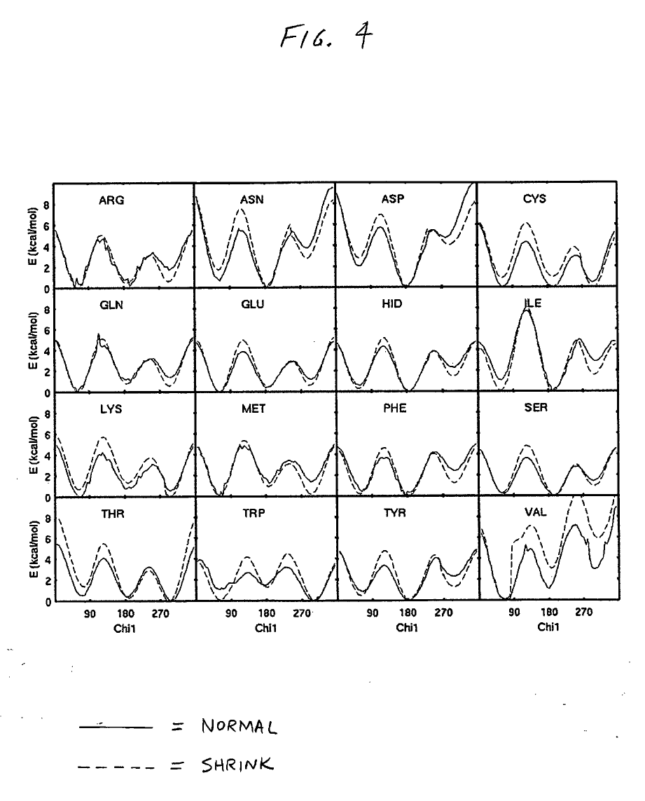

The energy profiles of other 16 dipeptides (Ace-X-Nhe), except Ala, Gly, and Pro, were also calculated by restrained energy minimization for the normal and reduced (λ=0.6) side chains and are shown in FIG. 4. The high degree of similarity is quite evident. Although the energy minima have been well maintained, for some amino acids (e.g., Cys, Lys, and Trp), the relative ordering of minima was changed by small amount. For Val, although the relative ordering of the three energy minima was preserved, the energy gaps were increased. In the case of Trp, the energy minimum at 60° became close to the minimum at 300°. These differences gradually disappear as the side chains grow back to the normal size and, therefore, do not pose significant difficulties to the method. Overall, the energy profiles of all amino acids were well preserved after the reduction of side chain sizes.

ii. Free Energy Profile with Scaled Side Chain

An important goal of the present invention is to effectively reduce the free energy barriers while still retain the basic features (e.g., minima) of the free energy surface. Because of the scaled side chains, interactions with the neighboring amino acids are expected to change. This can also change the energy and free energy profiles. Intuitively, one may expect that this can reduce the energy barriers for buried side chains. Yet, ideally, scaling the side chains should only reduce the energy barriers but should retain the positions of the lowest free energy minimum.

The Potential of Mean Force (PMF) was calculated using umbrella sampling and the weighted histogram analysis method (WHAM) to examine the side chain scaling. In these calculations, restrained simulations were conducted at a set of side chain dihedral angles. The PMF was obtained by post-processing using a program prepared by Alan Grossfield (http://dasher.wustl.edu/alan). For qualitative comparison, two sets of PMF results of human cell adhesion protein (PDB id 1fna) were generated, one for the normal protein, the other with all side-chains scaled by λ=0.6. With the backbone fixed, the side-chain χ1 angle of Ser50 was varied from 5° to 360° with a 5° increment. A 100 ps restrained MD simulation was performed at each χ1 angle. For each set of PMF, 72 trajectories and a total of 7.2 ns simulation was collected for analysis.

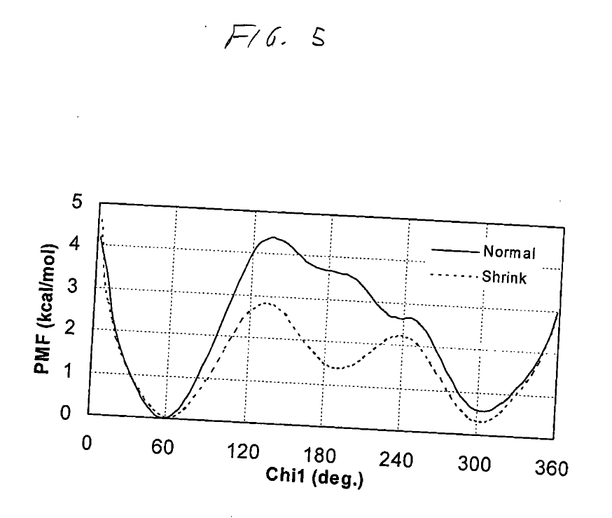

The results are illustrated in FIG. 5 which shows the calculated PMF for a partially exposed Ser50 side chain of protein 1fna. Unlike the dipeptide energy profiles that mainly reflect the interaction between side chain and main chain, the PMF profile is influenced also by the local environment. Since the side chain shrinking increased the distances and changed the interactions with other neighboring side chain groups, differences in the PMF profiles after shrinking are expected. However, one may wish to retain the free energy minima while reducing the barrier. This was indeed the case. The two free energy minima and the lowest free energy minimum were well retained and the barrier separating these two minima was reduced by about 2.0 kcal/mol, equivalent to more than 20 times enhancement in terms of barrier-crossing ability at the room temperature (300 K). Thus, the side chain conformational sampling has been significantly enhanced because of the smoother free energy landscape. In the reduced-size state, the side chain exhibits an additional energy minimum near 200°. Since Ser50 is a partially exposed side chain in 1fna with 63.5% of its surface exposed, greater reduction in the free energy barriers is expect for the buried and long side chains.

iii. Single Buried Side-Chains

Single residue assignment and refinement is considered the simplest case since it avoids the combinatorial problem. The results represent the best possible assignment achievable by the method. The method of the present invention was tested on 17 buried residues of protein 1fna and the results are summarized in Table 1a, below. For the 17 buried residues, the final assignment was 100% correct. Here a “correct” assignment is such that the torsion angle is less than 40° away from the native conformation which is a typical criterion used in most other prior art side chain assignment studies. In spite of the poorly assigned initial (random) conformations, the refinement was very effective and efficient. More than half of the residues reached the native conformations after first cycle (10 ps). Twelve of the seventeen residues (70%) were correctly assigned within 10 cycles (110 ps). The slowest one was Ile15 which took 52 cycles (572 ps). In all cases, the native conformations were correctly maintained after they were selected from the Monte Carlo procedure. Besides the high efficiency, the accuracy was also encouraging. All of the assigned conformations were within 20° from the native conformations; more than 90% were within 10° and ˜80% were within 5°.

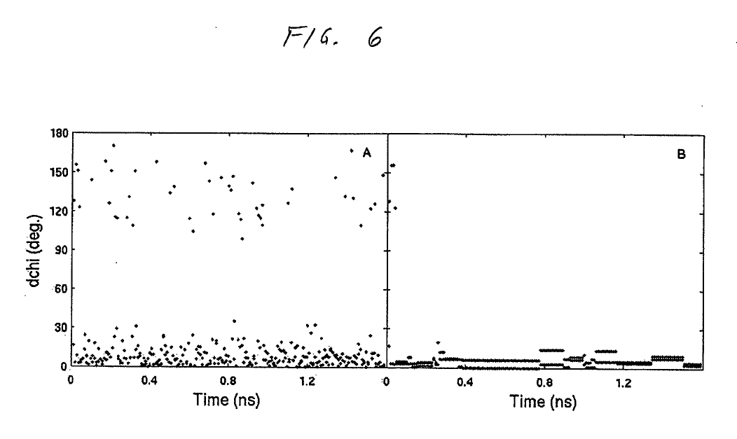

FIG. 6 illustrates the detailed sampling and Monte Carlo procedure of a representative side chain, Ile54. Starting from a random conformation, the side chain reached its native conformation within 40 ps (4 refinement cycles), as judged by the χ1 and χ2 torsion angles. Interestingly, although it frequently sampled other conformations later (Graph “A” in FIG. 6), the native conformation (Graph “B” in FIG. 6) was successfully selected during the Monte Carlo process. The results suggested that the underlying Duan et al AMBER ff03 force field is reasonably accurate when it is applied to the buried residues. Furthermore, the side chain torsion parameters were derived mainly by fitting to a set of representative organic compounds based on Cornell et al charge set while the Duan et al charge set was derived based on condensed phase quantum chemical calculations. The accuracy observed here suggests that the Duan et al charges are reasonably compatible with the side chain torsion parameters.

iv. Multiple Buried Side Chains

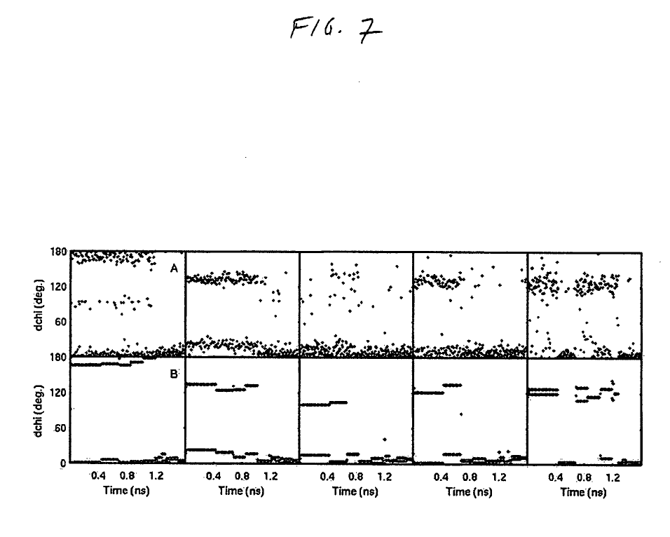

Simultaneous refinement of multiple buried side chains is the next level of challenge. Formally, this is a combinatorial problem because one may potentially try all possible combinations to find the optimum conformation when the side chains are correctly assigned. We first tested the method against a case of 5 buried residues. These five residual were close in space with typical distance of about 3.0-4.0 Å. The results are shown in FIG. 7. Both χ1 and χ2 of all 5 residues were correctly assigned after ˜1.2 ns. Comparing with single residue assignment, longer time was needed to find the native conformations. Even though all 5 residues found their respective correct conformations individually much earlier than 1.2 ns (as shown in the horizontal row of graphs in FIG. 7 beginning with Graph “A”), the correct conformations were not kept in the Monte Carlo steps. Nevertheless, when all 5 residues reached the correct side-chain conformations, they were selected by the Monte Carlo procedure because the correct conformation has the lowest energy (as shown in the horizontal row of graphs in FIG. 7 beginning with Graph “B”).

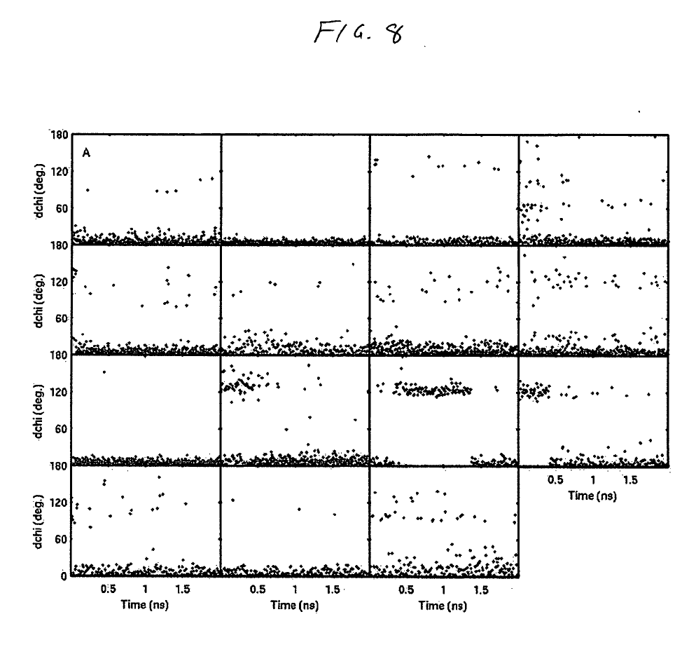

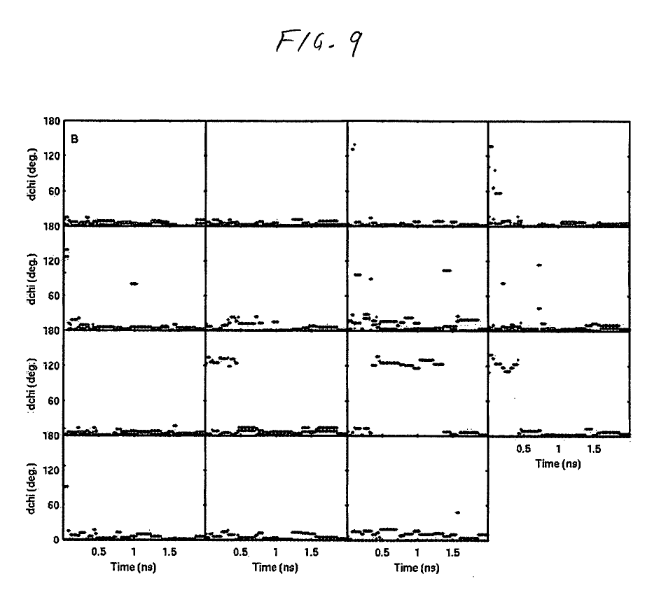

The method of the present invention was also tested on all buried residues of the protein 1fna, as shown in FIGS. 8 and 9. The terminal residues and Gly and Ala residues were excluded and a total of 15 buried residues were chosen which constituted the entire core of the protein and were closely packed. FIG. 8 shows the actual samplings and final assignments of the 15 residues. The results are also summarized in Table 1b, below. Among the 15 side chains, the χ1 torsion angles of 13 side chains were initially poorly assigned due to the random assignment and the initial deviations were greater than 100°. Similarly, half of the χ2 torsion angles were also poorly assigned. Within ˜1.5 ns, all χ1 and χ2 were corrected by the Monte Carlo procedure, as shown in FIG. 9. Even though almost all of the side chains started from completely wrong initial conformations, 13 of the 15 side chains (except Ile65 and Val43) found their native conformations almost immediately. After it found its native conformation, Thr66 moved to a non-native position later and became the last residue that eventually went back to the correct conformation. When it finally moved back to its native position at ˜1.5 ns, all the side-chains were in their native conformations and all the native side-chain conformations were kept for the rest of the simulation time.

One challenge for side chain assignment is that the problem is inherently combinatorial. Because the search space grows exponentially as the number of side chains increases, much longer time is needed to find the optimal packing when the number of residues increases. This appeared to be less of an issue because similar time was needed to find the native assignment for both 5 residues (˜1.2 ns) and 15 residues (˜1.5 ns). This was perhaps because the method relies on the physical interactions among residues and allows them to adjust to the optimal conformations gradually and to adjust to the favorable positions dictated by the energy profile. The reduced side chains allow them to rotate relatively freely. As a consequence, the side chains experience a smooth energy landscape which funnels them to the optimal position dictated by the force field. This scenario is analogous to what has been envisaged by the folding funnel theory in which the funnel-shaped protein folding free energy landscape helped to reduce an inherently combinatorial problem. It is noted that although these results are encouraging, they are insufficient to show the elimination of the combinatorial problem.

It is also noteworthy that nearly all the refined side chains were within 10° derivation from their native conformations. The largest deviation was Ile54 whose average χ1 was about 12.2° from its native conformation. This high level of accuracy is quite encouraging.

To further examine the accuracy of the present invention, the method was tested on 5 other proteins selected from PDB. The results are compared with SCWRL310 (http://dunbrack.fccc.edu/SCWRL3.php) assignments (Table 2, below). With the grow to fit method of the present invention, all the χ1 and χ2 of each protein were accurately assigned within 1.6 ns of the 2.2 ns simulations and the assignment accuracy was nearly 100%. The only exception was one Lys side chain of protein 1vie, whose assigned χ1 angle was 53° away from its native position. This particular residue was 19.6% exposed, slightly below the cutoff (20%) of buried residue. Therefore, its conformation could have been under the influence of solvent. Nevertheless, similar to the 1fna case, most of the residues were assigned quickly within only several Monte Carlo cycles.

The average refinement result (χ1 and χ2) of each protein was less than 10° derivation from their native conformations. The successful assignments on different proteins with such high accuracy were a clear validation of the method on buried residues. Overall, 94% of the torsion angles were within 20° from the native conformation, 79% were within 10° and 42% were within 5°. Although SCWRL3 also showed excellent result of 93.5% accuracy, 9 out of the 139 dihedral angles were more than 40° away from native conformations. Because of those incorrectly assigned residues, the average deviation from native conformation was systematically larger than our results. The successful assignment on different proteins with such high accuracy was a clear validation of the Grow to fit method of the present invention on buried residues. This comparison illustrates that the Grow to fit method has a slight accuracy advantage over the SCWRL3; the latter represents one of the best rotamer-based side chain assignment methods.

v. Exposed Side-Chains

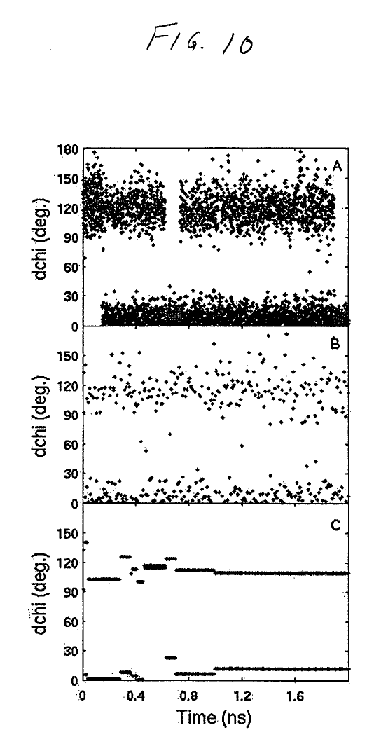

As an example, FIG. 10 shows the results of an exposed residue Glu41 of protein 1fna in a single side chain assignment test. The differences between the initial random assignment and the native conformations were 116.9° and 132.6° for χ1 and χ2, respectively. Graph “A” in FIG. 10 shows that the conformational sampling of a regular restrained MD simulation. Graph “B” in FIG. 10 is the sampling results of G2FMD simulation, which presented the actual conformation of each fully re-grown snapshot. Graph “C” in FIG. 10 is the saved conformation after Monte Carlo selection; which were the final conformations of each cycle.

The χ1 angle was correctly assigned, but χ2 angle was far away from its native conformation in both the G2FMD and MD results. The incorrect χ2 assignment was not a sampling problem, because both simulations sampled the native χ2 conformations many times. Thus, the bias toward a non-native conformation instead of native is likely linked to several factors, including possible errors in the underlying energetic representation and solvent models. Another factor that might have important contribution is the crystal packing effect since the experimental structures were obtained in crystalline environment and our assignment was done in solution phase. Similar results were obtained on other exposed residues (Lys49, Lys58, Lys81) (data not shown). Despite these, comparison between G2FMD (Graph A) and MD (Graph C) reinforced the notion that the G2FMD method significantly enhances the sampling efficiency: MD tends to stay in certain conformation for long time while G2FMD was able to sample among different conformations much more frequently because of the smoother energy landscape.

vi. Side-Chain Assignments of the Entire Proteins

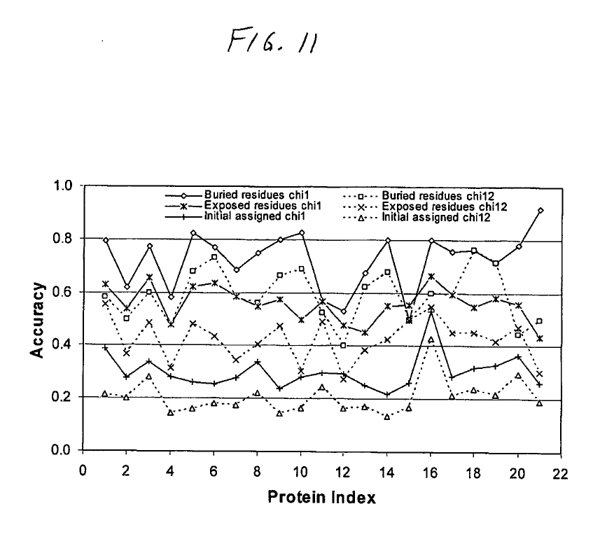

We tested the Grow to fit method of the present invention on a set of total 21 proteins, including the 6 proteins that were used in buried side chain tests discussed earlier. In this test, the assignments were performed to the whole proteins. The final assignment results are presented in FIG. 11. Side-chain angle was considered correctly assigned if it was within 40° of its experimental value which is a typical criterion used by most side chain assignment studies.

Among the assignments, the buried side chains were systematically better (73% and 59% for χ1 and χ1+2) than the exposed residues (56% and 42%). This suggests that solvent model and, perhaps, crystal packing played important roles.

In comparison, nearly 100% accuracy was achieved in the assignments of the buried side chains when the exposed side chains were kept near their native conformations. This was probably an indication of cooperative effect in the sense that the interactions between the exposed and the buried side chains can influence the assignment; lower assignment accuracy of the exposed side chains can propagate and affect the accuracy of the buried ones. Nevertheless, overall, the average assignment accuracy of the 21 proteins was 64% and 51% for χ1 and χ1+2, respectively, including both buried and exposed side chains.

TABLE 1a
Statistical results of single side chain assignment on each buried residue
Single side chain assignment

| | | Init. | Init. | Success | Final | Stdev | Final | Stdev |
|---|---|---|---|---|---|---|---|---|
| | Res | δχ₁ | δχ₂ | (χ₁₊₂) | (δχ₁) | (δχ₁) | (δχ₂) | (δχ₂) |
| Res | Index | (degrees) | (degrees) | (cycles) | (degrees) | (degrees) | (degrees) | (degrees) |
| LEU | 13 | 119.0 | 17.2 | 4 | 3.1 | 2.7 | 4.9 | 2.8 |
| ILE | 15 | 134.5 | 15.3 | 52 | 4.7 | 4.2 | 3.2 | 3.0 |
| TRP | 17 | 120.6 | 95.8 | 1 | 2.5 | 1.7 | 4.1 | 4.0 |
| VAL | 24 | 122.3 | | 27 | 4.8 | 1.9 | | |
| TYR | 27 | 122.2 | 93.3 | 1 | 2.8 | 2.2 | 3.7 | 2.8 |
| ILE | 29 | 127.0 | 4.5 | 9 | 2.6 | 1.5 | 4.9 | 2.8 |
| THR | 30 | 4.8 | | 1 | 2.4 | 4.2 | | |
| ILE | 54 | 130.0 | 3.4 | 4 | 6.8 | 3.8 | 3.3 | 2.6 |
| LEU | 57 | 124.0 | 117.7 | 4 | 2.4 | 1.8 | 5.6 | 4.5 |
| TYR | 63 | 108.1 | 93.3 | 1 | 4.8 | 0.0 | 16.3 | 0.0 |
| ILE | 65 | 127.4 | 7.0 | 11 | 3.9 | 1.8 | 6.3 | 2.4 |
| THR | 66 | 116.7 | | 1 | 0.8 | 0.0 | | |
| VAL | 67 | 123.1 | | 1 | 4.6 | 0.0 | | |
| VAL | 70 | 128.1 | | 13 | 4.8 | 1.9 | | |
| THR | 71 | 9.7 | | 1 | 11.3 | 5.7 | | |
| SER | 79 | 112.9 | | 18 (76) | 6.0 | 2.3 | | |
| ILE | 83 | 119.1 | 0.5 | 1 | 2.9 | 2.3 | 2.9 | 2.2 |

TABLE 1b
Statistical results of multi side chain assignment on all buried residues
Assignment of buried residues

| | | Init. | Init. | Success | Final | Stdev | Final | Stdev |
|---|---|---|---|---|---|---|---|---|
| | Res | δχ₁ | δχ₂ | (χ₁₊₂) | (δχ₁) | (δχ₁) | (δχ₂) | (δχ₂) |
| Res | Index | (degrees) | (degrees) | (cycles) | (degrees) | (degrees) | (degrees) | (degrees) |
| ILE | 15 | 134.5 | 15.3 | 1 | 3.5 | 4.0 | 2.0 | 1.7 |
| TRP | 17 | 120.6 | 95.8 | 1 | 2.2 | 1.0 | 5.4 | 3.2 |
| VAL | 24 | 121.4 | | 11 | 3.3 | 2.0 | | |
| TYR | 27 | 122.2 | 93.3 | 20 | 1.9 | 0.2 | 4.1 | 1.6 |
| ILE | 29 | 127 | 4.5 | 7 (104) | 4.0 | 2.1 | 2.4 | 2.4 |
| THR | 30 | 4.8 | | 1 | 4.5 | 2.4 | | |
| ILE | 54 | 129 | 3.4 | 1 (148) | 12.2 | 7.7 | 3.6 | 6.5 |
| LEU | 57 | 124 | 117.7 | 1 (74) | 5.1 | 4.5 | 5.6 | 3.4 |
| TYR | 63 | 108.1 | 93.3 | 1 | 3.4 | 1.3 | 3.9 | 4.4 |
| ILE | 65 | 127.4 | 7 | 46 | 8.5 | 5.8 | 6.7 | 2.4 |
| THR | 66 | 116.7 | | 138 | 3.9 | 2.0 | | |
| VAL | 67 | 123.1 | | 43 | 5.1 | 2.0 | | |
| VAL | 70 | 128.1 | | 7 | 2.9 | 1.9 | | |
| THR | 71 | 9.7 | | 1 | 5.2 | 2.5 | | |
| SER | 79 | 112.9 | | 1 | 5.9 | 2.7 | | |

*δχ₁, δχ₂ represented the deviation from native χ₁ and χ₂, respectively
*Success (cycles) represents the first time when both sampled the “correct” conformations (deviation <40°). The numbers within parentheses indicate that the side-chains moved to other conformation later and the numbers represent the final cycle when they moved back to the correct conformation.

TABLE 2
Statistical results of buried side-chains predictions on different proteins

| | | | Initial Assignment | | G2FMD | | | SCWRL3 |
|---|---|---|---|---|---|---|---|---|
| | | | Ave δχ₁ | | Success | Ave δχ₁ | | Ave δχ₁ |
| Protein | Total | Buried | and δχ₂ | Stdev | (χ₁₊₂) | and δχ₂ | Stdev | & δχ₂ |
| ID | Residues | Residues | (degrees) | (degrees) | (cycles) | (degrees) | (degrees) | (degrees) |
| 1fna | 91 | 15 | 88.7 | 50.6 | 148 | 4.6 | 2.3 | 5.9 |
| 1a68 | 87 | 22 | 89.7 | 44.7 | 146 | 8.3 | 7.1 | 14.5 |
| 1cyo | 88 | 14 | 100.0 | 45.9 | 105 | 7.1 | 4.7 | 15.5 |
| 1msi | 66 | 11 | 86.0 | 49.2 | 74 | 6.7 | 5.1 | 3.3 |
| 1vie | 60 | 9 | 88.2 | 41.7 | 60 | 9.9 | 5.7 | 29.5 |
| 1vqb | 86 | 10 | 86.2 | 48.4 | 4 | 6.4 | 3.9 | 10.9 |

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for modeling a molecule having a refined protein structure, comprising the steps of:
producing a reduced molecular model of a molecule; and
growing said reduced molecular model to a normal size while adjusting to a local environment using a molecular dynamics simulation process.

2. The method of claim 1 wherein said molecule comprises a polypeptide.

3. The method of claim 1 wherein said molecule comprises a ligand.

4. The method of claim 1, further comprising adjusting a scaling term of an energy function corresponding to said molecule prior to producing said reduced molecular model.

5. The method of claim 4, further comprising allowing said energy function to define said local environment.

6. The method of claim 4, wherein the step of adjusting a scaling term comprises adjusting an angle of the energy function.

7. The method of claim 4, wherein the step of adjusting a scaling term comprises adjusting a dihedral term of the energy function.

8. The method of claim 4, wherein the step of adjusting a scaling term comprises adjusting a bond term of the energy function.

9. The method of claim 4, wherein the step of adjusting a scaling term comprises adjusting an electrostatic term of the energy function.

10. The method of claim 4, wherein the step of adjusting a scaling term comprises adjusting a van der Waals term of the energy function.

11. The method of claim 1, wherein the step of growing said reduced molecule comprises shrinking side chains of the molecule.

12. The method of claim 10, wherein the step of growing said reduced molecule comprises growing said side chains to a normal size.

13. The method of claim 1, further comprising performing an energy minimization process on the reduced molecule.

14. The method of claim 13, further comprising saving minimized energy parameters of the reduced molecule.

15. The method of claim 14, further comprising re-modeling said reduced molecular model using the minimized energy parameters.

16. A method for modeling a molecule having a refined protein structure, comprising the steps of:
providing a model of a molecule and a local environment in a computer system;
adjusting a scaling term of an energy function corresponding to said modecule;
reducing the model to form a reduced molecular model; and
growing said reduced molecular model to a normal size in said local environment, said energy function controlling growth of said reduced molecular model to produce a refined protein structure for said reduced molecular model.

17. The method of claim 16, wherein the step of reducing said model comprises shrinking side chains of the model.

18. The method of claim 17, wherein the step of growing said reduced molecule comprises growing said side chains to a normal size.

19. The method of claim 16, further comprising performing an energy minimization process on the reduced molecular model.

20. The method of claim 19, further comprising saving minimized energy parameters of the reduced molecular model.

21. The method of claim 20, further comprising re-modeling the reduced molecular model using the minimized energy parameters.

22. A method for modeling protein side chain assignment, comprising the steps of:
reducing a high energy barrier associated with a molecule to produce a model of a smooth energy surface in a computer system; and
modeling growth of a protein structure in said computer system by simulating assignments of protein side chains, said assignments being controlled by said model of said smooth energy surface.
